(19) United States
(12) Patent Application Publication
(10) Pub. No.: US 2025/0189717 A1
(43) Pub. Date: Jun. 12, 2025

(54) MULTICORE OPTICAL FIBER, OPTICAL COMBINER, AND METHOD OF MEASURING FIBER CHARACTERISTICS

(71) Applicant: SUMITOMO ELECTRIC INDUSTRIES, LTD., Osaka (JP)

(72) Inventors: Yuto KOBAYASHI, Osaka (JP); Tetsuya HAYASHI, Osaka (JP)

(21) Appl. No.: 18/846,341

(22) PCT Filed: Mar. 13, 2023
(86) PCT No.: PCT/JP2023/009708

§ 371 Date: Sep. 12, 2024

(30) Foreign Application Priority Data
Mar. 17, 2022 (JP) 2022-042673
Dec. 21, 2022 (WO) PCT/JP2022/047220

(51) Int. Cl. G02B 6/02; G01M 11/00; G02B 6/30

(52) U.S. Cl. CPC G02B 6/02042; G01M 11/333; G02B 6/30

(57) ABSTRACT

An MCF according to an embodiment and the like has a structure for suppressing increases in connection loss even when there is axial deviation between the cores to be optically connected. The MCF comprises a plurality of cores, and a common cladding surrounding the plurality of cores. At the wavelength of 1260 nm, ten or more LP modes, including the fundamental mode, are guided for 1 m or more.

### TECHNICAL FIELD

The present disclosure relates to a multicore optical fiber (hereinafter, referred to as “MCF”), an optical combiner, and a method of measuring fiber characteristics.

This application claims priorities based on Japanese Patent Applications No. 2022-042673 filed on Mar. 17, 2022 and the international application PCT/JP2022/047220 filed on Dec. 21, 2022, and the entire contents described in the applications are incorporated herein by reference.

### BACKGROUND ART

Patent literature 1 discloses a method of measuring crosstalk (hereinafter referred to as “XT”) of an MCF using an Optical Time Domain Reflectometer (OTDR), and also discloses that an optical combiner is used for efficient measurement. In the Patent Literature 2, a bundle type optical combiner (FIFO: FAN-IN/FAN-OUT) for a Few-Mode is disclosed, and a Few-Mode MCF (Few-Mode MCF) capable of guiding four kinds of LP (Linearly Polarized) modes in each core is connected to the FIFO. Further, Patent Literature 3 discloses an example of a single core optical fiber (hereinafter, referred to as “SCF”) that reduces connection loss in a graded-index (GI) type refractive index profile core. Although the FIFO alone is sometimes called an optical combiner, in this specification, the SCF and the MCF for connection are also called an “optical combiner” in addition to the FIFO.

On the other hand, Non-patent literature 1 discloses the design of an uncoupled MCF capable of guiding nine types of LP modes in each core. Non-patent literature 2 defines a method of measuring the cutoff wavelength of an SCF having a single-mode core. Further, in Non-patent literature 3, the characteristics of MCF in which a plurality of cores each having a core diameter of 26 μm are arranged at a core pitch of 39 μm are evaluated. In the MCF of Non-patent literature 3, the difference in refractive index between cores is 0.016, and each core has a GI-type refractive index profile. In each core, about nine types of LP modes can be guided.

### CITATION LIST

### Patent Literatures

Patent literature 1: Japanese Unexamined Patent Application Publication No. 2012-202827
Patent literature 2: Japanese Unexamined Patent Application Publication No. 2017-146354
Patent literature 3: Japanese Unexamined Patent Application Publication No. 2009-258354

### Non-Patent Literatures

Non-patent literature 1: Taiji Sakamoto, at al., “Spatial Density and Splicing Characteristic Optimized Few-Mode Multi-Core Fiber”, JURNAL OF LIGHTWAVE TECHNOLOGY, VOL. 38, NO. 16, pp. 4490-4496, Aug. 15, 2020
Non-patent literature 2: ITU-T G.650.1
Non-patent literature 3: Benyuan Zhu, at al., “7×10-Gb/s Multicore Multimode Fiber Transmissions for Parallel Optical Data Links”, ECOC2010, We.6. B.3, 19-23 September, 2010, Torino, Italy
Non-patent literature 4: Y. Tottori, et al., “Low Loss Optical Connection Module for Seven-Core Multicore Fiber and Seven Single-Mode Fibers”, IEEE PHOTONICS TECHNOLOGY LETTERS, VOL. 24, NO. 21, pp. 1926-1928, Nov. 1, 2012
Non-patent literature 5: Y. Tottori, et al., “Integrated optical connection module for 7-core multi-core fiber and 7 single mode fibers”, 2013 IEEE MC3.2, pp. 82-83

### SUMMARY OF INVENTION

In order to solve the problem, an MCF of the present disclosure includes a plurality of cores extending along a center axis, and a common cladding surrounding each of the plurality of cores. At a wavelength of 1260 nm, ten or more types of LP modes including a fundamental mode are guided in each of the plurality of cores by 1 m or more.

### BRIEF DESCRIPTION OF DRAWINGS

FIG. 1 is a diagram showing the basic structure of an MCF and an optical combiner according to the present disclosure.

FIG. 2 is a diagram for explaining another example of the FIFO device applicable to the optical combiner of the present disclosure.

FIG. 3 is a diagram for explaining each end surface structure of the constituent parts of the optical combiner having a different number of cores as a modification of the optical combiner shown in FIG. 2.

FIG. 4 is a diagram for explaining still another example of the FIFO device applicable to the optical combiner of the present disclosure.

FIG. 5 is a diagram for explaining a relative refractive index difference volume V.

FIG. 6 is a diagram showing a measurement apparatus and a measurement result for measuring a cutoff wavelength as an example of a fiber characteristic of a measurement target.

FIG. 7 is a graph showing the wavelength dependence of connection loss for various samples that do not satisfy the connection condition required for the MCF of the present disclosure in the measurement of cutoff wavelength.

FIG. 8 is a diagram for explaining the XT condition applied to the MCF of the present disclosure.

FIG. 9 is a diagram showing a measurement apparatus for measuring wavelength dependence of transmission loss as an example of fiber characteristics of a measurement target.

### DETAILED DESCRIPTION

### Problems to be Solved by Present Disclosure

The inventors have studied the above-described conventional techniques and have found the following problems.

For example, in a standard measurement method such as “cutoff wavelength” or “wavelength dependence of transmission loss”, there is a problem that the MCF cannot be collectively measured even when the optical combiner disclosed in Patent Literature 1 is used. This is because the measurement of the “cutoff wavelength” or the “wavelength dependence of transmission loss” requires reception of a plurality of LP modes. However, the existing optical combiner can receive only four types of LP modes at most as in Patent literature 2, and cannot sufficiently reduce the connection loss due to the axial misalignment. Further, as described in Non-patent literature 1 and Non-patent literature 3, only about nine types of LP modes can be guided in the existing fiber design even in the case of MCF, and a new MCF is required. As for a specific numerical value of the connection loss between the optical combiner and the measurement target, as described in Non-patent literature 2, in a standard measurement method, a parallel line is drawn on 0.1 dB of a line segment serving as a portion of a graph on the long wavelength side of the graph indicating the measurement value for each wavelength, and the wavelength at the intersection of the parallel line and the graph is determined as the cutoff wavelength. Thus, the connection loss when the measurement light is input to and output from the measurement target needs to be sufficiently smaller than 0.1 dB.

As another example, when an SCF for reducing connection loss as in Patent literature 3 is used as a light receiving unit for receiving light from each core of a measurement target, there is a problem in that XT between cores in the measurement target increases. That is, in order to reduce the connection loss, the MCF in which more than nine types of LP modes are guided through each core is required. However, when more LP modes are guided, the core diameter of each core also increases, and thus XT between cores in a measurement-target multicore optical fiber (hereinafter, referred to as a “measured MCF”) increases. In this case, signals for each core are mixed, and thus accurate measurement cannot be performed.

The present disclosure has been made to solve the above-described problems, and an object of the present disclosure is to provide an MCF including a structure for suppressing an increase in connection loss even when an axial misalignment occurs between cores to be optically connected, an optical combiner including the MCF, and a fiber characteristic measurement method using the MCF.

### Advantageous Effects of Present Disclosure

According to the MCF of the present disclosure, in the connection between the MCF and another optical fiber serving as a measurement target, even in a state where an axial misalignment has occurred between cores to be optically connected, an increase in connection loss can be effectively suppressed.

### Description of Embodiments of Present Disclosure

First, the contents of embodiments of the present disclosure will be described by listing them individually.

(1) The MCF of the present disclosure may include a plurality of cores extending along a center axis, a common cladding surrounding each of the plurality of cores and may have the following first structure. The first structure, at a wavelength of 1260 nm, ten or more types of LP modes including a fundamental mode are guided in each of the plurality of cores by 1 m or more.

According to the MCF of the present disclosure, the connection loss with respect to the axial misalignment can be reduced by guiding ten or more types of LP modes including higher-order modes in addition to the fundamental mode by the 1 m or more in each core. It is noted that, in the present specification, the state in which “the LP mode is guided” means a state in which the transmission loss of the LP mode after 1 m propagation in the core to be guided is 3.01 dB or less. Further, a state of “axis misalignment” means a state in which the center axes of both cores to be optically connected each other are separated by 1 μm or more, and the axis misalignment allowed in the MCF of the present disclosure is 5 μm or less.

(2) In (1), the MCF of the present disclosure may have the following second structure. The second structure can be combined with the first structure, and is defined by a relative refractive index difference volume V (μm²) of each of the plurality of cores, the relative refractive index difference volumes V (μm²) of the each of the cores are defined on a cross-section of the MCF orthogonal to the center axis.

Specifically, in the second structure, the relative refractive index difference volume V (μm²) being obtained by integration of a relative refractive index difference of a target core with respect to a lowest refractive index region included in the common cladding in the reference cross-section from a center of the target core to the lowest refractive index region, satisfies a relationship below.

2.2302≤V

This relative equation is a specific condition for guiding ten or more types of LP modes including higher-order modes in addition to the fundamental mode in each core, and is a condition for obtaining a normalized frequency v_eff of 8.6 or more when the refractive index profile of the core is approximated to a step index type.

(3) In (1), the MCF of the present disclosure may have the following third structure. The third structure has thirteen or more types of LP modes. In this way, thirteen or more types of LP modes including the higher-order modes in addition to the fundamental mode are guided through the cores by 1 m or more, and thus the connection loss with respect to the axial misalignment can be further reduced. Note that the mode group including thirteen or more types of LP modes includes the mode group including ten or more types of LP modes described above. Further, the “mode group” that comprehensively defines the modes guided in the cores may include modes other than the LP mode.

(4) In (3), the MCF of the present disclosure may have the following fourth structure. The fourth structure can be combined with the third structure, and is defined by a relative refractive index difference volume V (μm²) of each of the plurality of cores, the relative refractive index difference volumes V (μm²) of each of the cores are defined on a cross-section of the MCF orthogonal to the center axis. However, in the fourth structure, the relative refractive index difference volume V (μm²) being obtained by integration of a relative refractive index difference of a target core with respect to a lowest refractive index region included in the common cladding in the reference cross-section from a center of the target core to the lowest refractive index region, satisfies a relationship below.

2.9256≤V

This relative equation is a specific condition for guiding thirteen or more types of LP modes including higher-order modes in addition to the fundamental mode in each core, and is a condition for the normalized frequency v_eff of 9.85 or more when the refractive index profile of the core is approximated to a step index type.

(5) The MCF of the present disclosure may include a plurality of cores extending along a center axis, and a common cladding surrounding each of the plurality of cores, and a structure defined by a relative refractive index difference volume V (μm²) of each of the plurality of cores. A relative refractive index difference volume V (μm²) of each of the plurality of cores defined on a cross-section of the MCF orthogonal to the center axis. Specifically, in the second structure, the relative refractive index difference volume V (μm²) being obtained by integration of a relative refractive index difference of a target core with respect to a lowest refractive index region included in the common cladding in the reference cross-section from a center of the target core to the lowest refractive index region, satisfies a relationship below.

2.2302≤V

This relative equation is a specific condition for guiding ten or more types of LP modes including higher-order modes in addition to the fundamental mode in each core, and is a condition for obtaining a normalized frequency v_eff of 8.6 or more when the refractive index profile of the core is approximated to a step index type.

(6) In (5), the relative refractive index difference volume V (μm²) may satisfy a relationship below.

2.9256≤V

This relative equation is a specific condition for guiding thirteen or more types of LP modes including higher-order modes in addition to the fundamental mode in each core, and is a condition for the normalized frequency v_eff of 9.85 or more when the refractive index profile of the core is approximated to a step index type.

(7) In any one of (2), (4), (5), and (6), the relative refractive index difference volume V (μm²) may be 15 or less.

When relative refractive index difference volume V (μm²) is fifteen or less, excessive attenuation of the light intensity of light propagating in each core, for example, light used for measurement, is effectively suppressed.

(8) In the above (7), the relative refractive index difference volume V (μm²) may be 11 or less. When relative refractive index difference volume V (μm²) is eleven or less, excessive attenuation of light propagating in each core is more effectively suppressed.

(9) In any one of (1) to (8), a first core having a radius a (μm) and a second core having a radius b (μm) may satisfy an adjacent relationship in which a center-to-center distance Λ (μm) is shortest among the plurality of cores, and the first core and the second core satisfy a relationship below.

$$34 \leq Λ \leq 46 \\ 0.6375 < ( a + b ) / Λ < 0.8625$$

(10) In the above (9), a first core and a second core may satisfy a relationship below.

$$34 \leq Λ \leq 46 \\ 0.675 \leq ( a + b ) / Λ < 0.825$$

By satisfying any of the relative equations, XT between cores in an adjacent relationship is effectively reduced.

(11) In any of (1) to (10), at least one of the plurality of cores may have a GI-type refractive index profile. In this case, in the connection between the MCF of the present disclosure and another MCF, the connection loss between cores to be optically connected is effectively reduced.

(12) In any one of the above (1) to (11), the MCF of the present disclosure may further include a plurality of trench portions corresponding one-to-one to the plurality of cores and each disposed to surround an outer circumference of a corresponding one of the plurality of cores, the plurality of trench portions each having a refractive index lower than a refractive index of the common cladding. In this case, XT can be effectively reduced.

(13) The optical combiner of the present disclosure may include the MCF according to any one of (1) to (12). In this case, the optical combiner is constituted by the MCF of the present disclosure and the optical waveguide device. The optical waveguide device includes a first end surface having a predetermined first core arrangement, a second end surface having a second core arrangement differing from the first core arrangement, and a plurality of cores provided between the first end surface and the second end surface. Further, the plurality of cores provided between the first end surface and the second end surface are optically connected one-to-one, at the first end surface, to the plurality of cores of the MCF of the present disclosure. The MCF of the present disclosure constitutes a portion of the optical combiner, and thus the configuration of the measurement apparatus for realizing a method of measuring fiber characteristics is facilitated. It is noted that, in the optical combiner of the present disclosure, each of the cores of the plurality of optical waveguide devices may be a multimode core.

(14) In (13), the optical waveguide device may include, as the plurality of cores, a plurality of SCF components. In this case, each of the plurality of SCF components has a first fiber end surface constituting a portion of the first end surface of the optical waveguide device, a second fiber end surface constituting a portion of the second end surface of the optical waveguide device, and a single core extending from the first fiber end surface to the second fiber end surface. Further, each of the plurality of SCF components has, at a side surface of a tip portion including the first fiber end surface, one or more flat surfaces. With the respective flat surfaces being fixed to each other in a state of facing each other, the first fiber end surfaces of the plurality of SCF components constitute the first end surface of the optical waveguide device. As described above, by constituting the optical waveguide device including the plurality of cores by using the plurality of SCF components, the optical waveguide device itself can be easily manufactured.

(15) In the above (14), the number of the plurality of SCF components may be two. In this case, the number of times of the flattening process for the side surfaces of the two SCF components to be prepared is only one. Thus, the optical combiner can be manufactured more easily.

(16) The optical combiner of the present disclosure may include the MCF of the present disclosure which is the MCF according to any one of (1) to (12), and an optical connection device. The optical connection device has a first end portion configured to hold a tip portion including an end surface of the MCF, a second end portion configured to hold a tip portion of each of a plurality of SCFs each having a core corresponding one-to-one to one of the plurality of cores of the MCF, a through hole extending from the first end portion to the second end portion and configured to cause a plurality of light fluxes to propagate, between the MCF and the plurality of SCFs, along different optical paths, and a spatial optical system configured to optically couple each of the plurality of cores of the MCF to a corresponding one of the cores of the plurality of SCFs. By arranging the spatial optical system between the plurality of cores of MCF and the cores of the plurality of SCF, it is possible to individually change the plurality of optical paths within through holes.

(17) In the above (16), the spatial optical system may include a GRIN lens. The GRIN lens is a refractive index distribution type lens, and by changing the input position of light from the core to the GRIN lens for each core of the plurality of cores of the MCF, the focal position can be adjusted in accordance with the installation position of the corresponding SCF.

(18) A method of measuring fiber characteristics of present disclosure, in order to measure the cutoff wavelength as the fiber characteristic, the MCF to be measured as the measurement target is prepared, the first optical transmission path is prepared, the fiber line including the measurement target is configured, the intensity of the measurement light is measured, and the cutoff wavelength of each core of the plurality of cores of measurement target is determined. The MCF to be measured as the measurement target has a first end surface and a second end surface, and has a plurality of cores each extending from the first end surface toward the second end surface. A first optical transmission path is arranged on a side of the first end surface or the second end surface of the measurement target and configured to function as an input-side optical transmission path or an output-side optical transmission path. The first optical transmission path includes, as the MCF of the present disclosure, a first multicore optical fiber (first MCF) having a structure identical to a structure of the MCF of the present disclosure according to any one of (1) to (12). A fiber line includes the first MCF and the measurement target, and is constituted by optically connecting the plurality of cores of the first MCF one-to-one to the plurality of cores of the measurement target. Such a configuration includes measuring, for each of a plurality of cores of the fiber line, intensity of measurement light while changing a wavelength of the measurement light, the measurement light being output from an output-side end surface of the fiber line after being input to an input-side end surface of the fiber line, and determining, as a fiber characteristic, a cutoff wavelength of each of the plurality of cores of the measurement target based on a measurement result relating to the measurement target.

It is noted that, the measurement light is light that is input to the input-side end surface of the fiber line and then output from the output-side end surface of the fiber line for each core of the plurality of cores of the fiber line. Further, the intensity measurement for each wavelength in the plurality of cores of the measurement target may be performed simultaneously for the plurality of cores or may be performed at different times for the plurality of cores. After the measurement is performed, the cutoff wavelength of each of the cores of the plurality of cores of measurement targets is determined as the fiber characteristic based on the measurement result of the measurement target. The method of measuring fiber characteristics of the present disclosure makes it possible to measure the fiber characteristic of each core in the MCF to be measured without increasing the connection loss between fibers by using the MCF of the present disclosure.

(19) In (18), the first optical transmission path may have a structure identical to the optical combiner of the above (13) or (16) as an optical combiner of the present disclosure. Specifically, the first optical transmission path may be an optical combiner including the first MCF and a first optical waveguide device. The first optical waveguide device has a first end surface having a predetermined first core arrangement, a second end surface having a second core arrangement differing from the first core arrangement, and a plurality of cores provided between the first end surface and the second end surface, the plurality of cores between the first end surface and the second end surface being optically connected one-to-one, at the first end surface, to the plurality of cores of the first MCF. Note that, the optical transmission path to which the structure identical to the structure of optical combiner of the present disclosure are not applied among the input-side optical transmission path and the output-side optical transmission path may be constituted such that the measurement light from the light source is input to all the cores of the MCF to be measured as the multimode light and the light from all the cores of the MCF to be measured can be received by the power meter as the multimode light. More specifically, the measurement light may be directly input from the light source to all cores of the MCF to be measured, or may be input to the MCF to be measured via a single-core large-diameter multimode optical fiber (hereinafter, referred to as “MMF”) or an MCF of the present disclosure. The light output from all cores of the MCF to be measured may be directly input to the power meter, or may be input to the power meter via a large-diameter MMF of a single core or an MCF of the present disclosure.

(20) In (18), a second optical transmission path may be further preparing a second optical transmission path positioned on a side opposite to the first optical transmission path with respect to the measurement target and configured to function as the input-side optical transmission path or the output-side optical transmission path. Like the first MCF, the second optical transmission path includes a second multicore optical fiber (second MCF) having a structure identical to the structure of the first MCF according to any one of (1) to (12), as the MCF of the present disclosure. Further, the fiber line is constituted by optically connecting the plurality of cores of the second MCF one-to-one to the plurality of cores of the measurement target such that the measurement target is placed between the first MCF and the second MCF. As described above, even when the optical combiner of the present disclosure is applied to both the input-side optical transmission path and the output-side optical transmission path, the same measurement result can be obtained without increasing the connection loss between the fibers. In this case, it is possible to increase the degree of freedom in designing a measurement apparatus for realizing the method of measuring fiber characteristics.

(21) In (20), the second optical transmission path may have a structure identical to the optical combiner of the above (13) or (16). Specifically, the second optical transmission path may be an optical combiner including the second MCF and a second optical waveguide device. The second optical waveguide device has a structure identical to the structure of first optical waveguide device, and has a first end surface having a predetermined first core arrangement, a second end surface having a second core arrangement differing from the first core arrangement, and a plurality of cores provided between the first end surface and the second end surface. The plurality of cores of the second optical waveguide device are optically connected to the plurality of cores of the second MCF in a one-to-one at the first end surface. In this case, it is also possible to increase the degree of freedom in designing the measurement apparatus for realizing method of measuring fiber characteristic.

(22) A method of measuring fiber characteristics of present disclosure, in order to measure the wavelength dependence of transmission loss by the cutback method as the fiber characteristic, the MCF to be measured as the first measurement target is prepared, the output-side optical transmission path including the MCF of the present disclosure is prepared, the first fiber line including the whole of the first measurement target is configured, and the optical characteristics in each core of the first measurement target after cutback are determined. The MCF to be measured, which is the first measurement target, has a first end surface and a second end surface, and has a plurality of cores extending from the first end surface toward the second end surface. The output-side optical transmission path is arranged on the second end surface side of the first measurement target, and includes the MCF of any one of (1) to (12) as the MCF of the present disclosure. The first fiber line includes an MCF of an output-side optical transmission path and an whole of a first measurement target, and is configured by optically connecting a plurality of cores of the MCF and a plurality of cores of the first measurement target in a one-to-one manner. In such a configuration, a first measurement step for a first measurement target and a second measurement step for a second measurement target that is a portion of the first measurement target are executed. It is noted that, the second measurement target is a portion of the first measurement target, and is a portion having a predetermined cutback length separated from the first measurement target.

In the first measurement step, for each core of the plurality of cores of the first fiber line, the intensity of the measurement light that is input to the input-side end surface of the first fiber line and then output from the output-side end surface of the first fiber line is measured. In the second measurement step, the intensity of the measurement light is measured by using the second fiber line including the second measurement target. That is, the second measurement target is a portion of the first measurement target, which is a portion having a predetermined cutback length separated from the first measurement target. The second fiber line is a fiber line from which the first measurement target is removed except for the second measurement target, and is constituted by optically connecting the plurality of cores of the second measurement target and the plurality of cores of the MCF constituting the portion of the first fiber line in a one-to-one manner. After the second fiber line is constituted, for each core of the second fiber line, intensity of measurement light that is input to an input-side end surface of the second fiber line and then output from an output-side end surface of the second fiber line is measured. As the fiber characteristic, the wavelength dependence of the transmission loss of each core of the plurality of cores of the first measurement target after the second measurement target is separated is determined based on the measurement results of the first measurement step and the second measurement step described above. Even with such a configuration, by using the MCF of the present disclosure, it is possible to measure the fiber characteristics of each core in the MCF to be measured without increasing the connection loss between fibers.

(23) In (22), the output-side optical transmission path may have a structure identical to the optical combiner of the above (13) or (16). Specifically, the output-side optical transmission path may be an optical combiner including the MCF included in the output-side optical transmission path, and an optical waveguide device. The optical waveguide device has a first end surface having a predetermined first core arrangement, a second end surface having a second core arrangement differing from the first core arrangement, and a plurality of cores provided between the first end surface and the second end surface. Further, the plurality of cores of the optical waveguide device are optically connected, at the first end surface, to the plurality of cores of the MCF, in a one-to-one manner. In this case, the degree of freedom in designing the measurement apparatus can be increased.

### Details of Embodiments of Present Disclosure

Specific examples of a multicore optical fiber (MCF), an optical combiner, and a method of measuring fiber characteristics according to the present disclosure will be described in detail with reference to the accompanying drawings. The present invention is not limited to these examples, but is defined by the scope of the claims, and is intended to include all modifications within the scope and meaning equivalent to the scope of the claims. In the description of the drawings, identical elements are denoted by identical reference numerals, and redundant description thereof will be omitted.

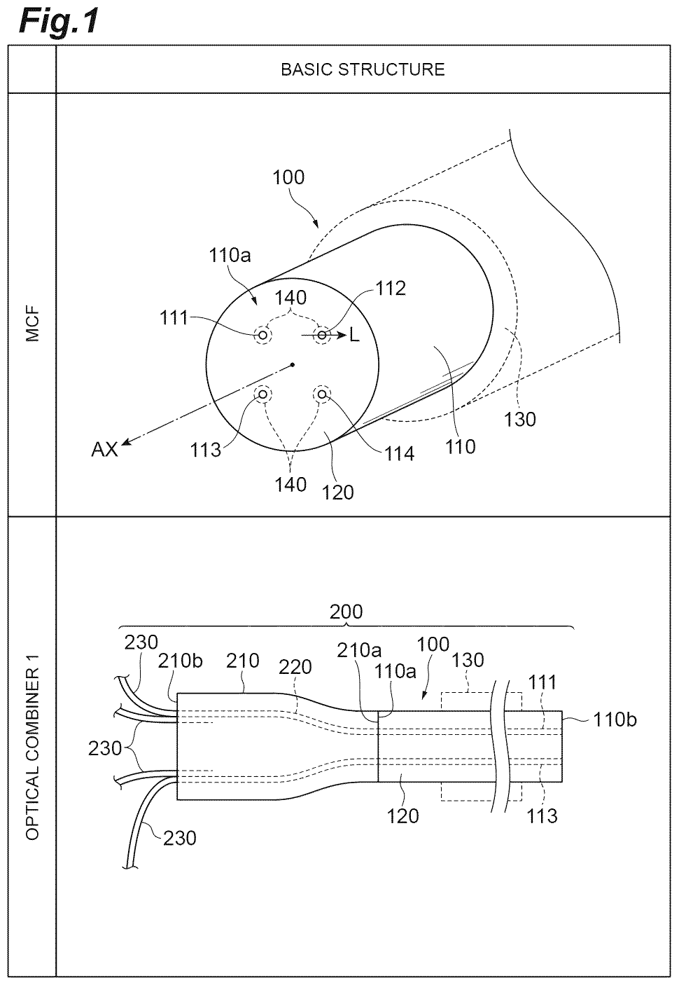

FIG. 1 is a diagram showing the basic structure of the MCF and the optical combiner according to the present disclosure (in FIG. 1, referred to as “basic structure”). The upper part of FIG. 1 (in FIG. 1, referred to as “MCF”) shows an example of an MCF 100 of the present disclosure. However, the number of cores in MCF 100 may be two or more, and is not limited to the example shown in the upper part of FIG. 1. In addition, in the lower part of FIG. 1 (in FIG. 1, referred to as “optical combiner 1”), as an example of an optical combiner 200 of the present disclosure, an example including a FIFO device 210 as a multimode optical waveguide is shown. In this specification, an element positioned on the input end side of the measurement target to which the measurement light is input as optical combiner 200 is referred to as an input side optical combiner 200A, and an element positioned on the output end side of the measurement target is referred to as an output side optical combiner 200B. In addition, as FIFO device 210, the FIFO device included in an input-side optical combiner 200A is referred to as a FAN-IN device 210A, and the FIFO device included in an output-side optical combiner 200B is referred to as a FAN-OUT device 210B.

MCF 100 of the present disclosure shown in the upper part of FIG. 1 includes a glass optical fiber 110 having a first end surface 110a and a second end surface 110b, and a resin covering 130 provided on the outer circumference surface of glass optical fiber 110. Glass optical fiber 110 includes cores 111 to 114 extending from first end surface 110a toward second end surface 110b along a fiber axis AX, which is the center axis, and a common cladding 120 surrounding cores 111 to 114. It is noted that, glass optical fiber 110 may include a plurality of trench portions 140 provided in correspondence with cores 111 to 114 in a one-to-one manner. Each of the plurality of trench portions 140 constitutes a portion of common cladding 120 and is the lowest relative refractive index region of common cladding 120. That is, the refractive index of each trench portion 140 is lower than the refractive index of common cladding 120 except for the plurality of trench portions 140. In a configuration in which the plurality of trench portion 140 are not provided in common cladding 120, the area of common cladding 120 becomes the lowest refractive index region.

Optical combiner 200 of the present disclosure shown in the lower part of FIG. 1 includes FIFO device 210 that functions as an optical waveguide device, a plurality of connection SCFs 230 each having a multimode core, and MCF 100 of the present disclosure. FIFO device 210 includes a plurality of cores 220, and the plurality of cores 220 and cores 111 to 114 of MCF 100 are optically connected each other on a first end surface 210a of FIFO device 210 in a one-to-one manner. Similarly, in a second end surface 210b of FIFO device 210, the plurality of cores 220 and the cores of a plurality of connection SCF 230 are optically connected in a one-to-one manner.

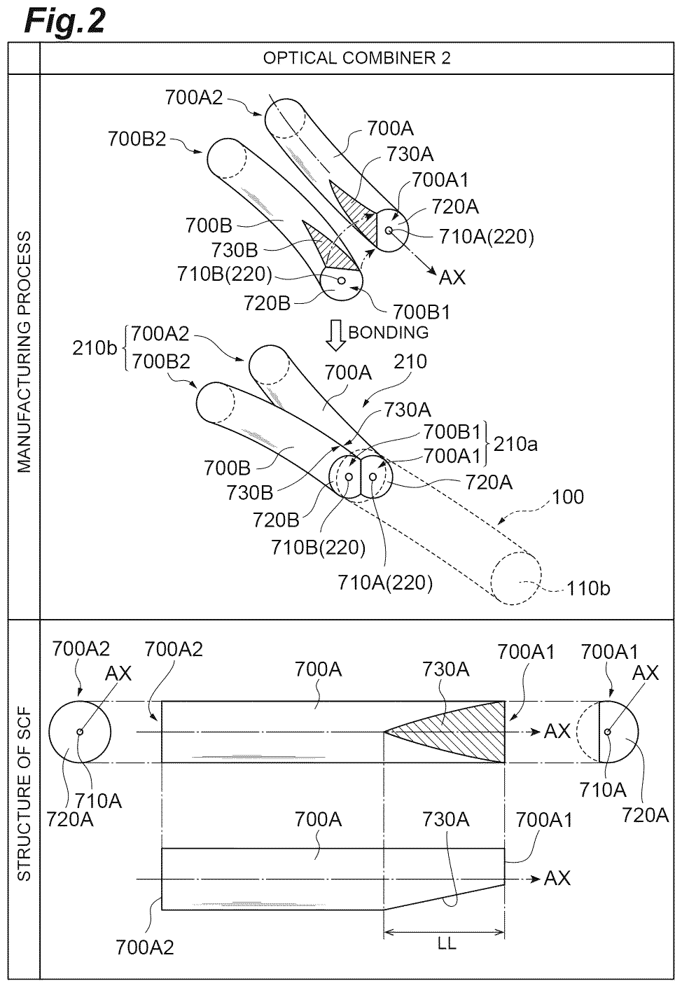

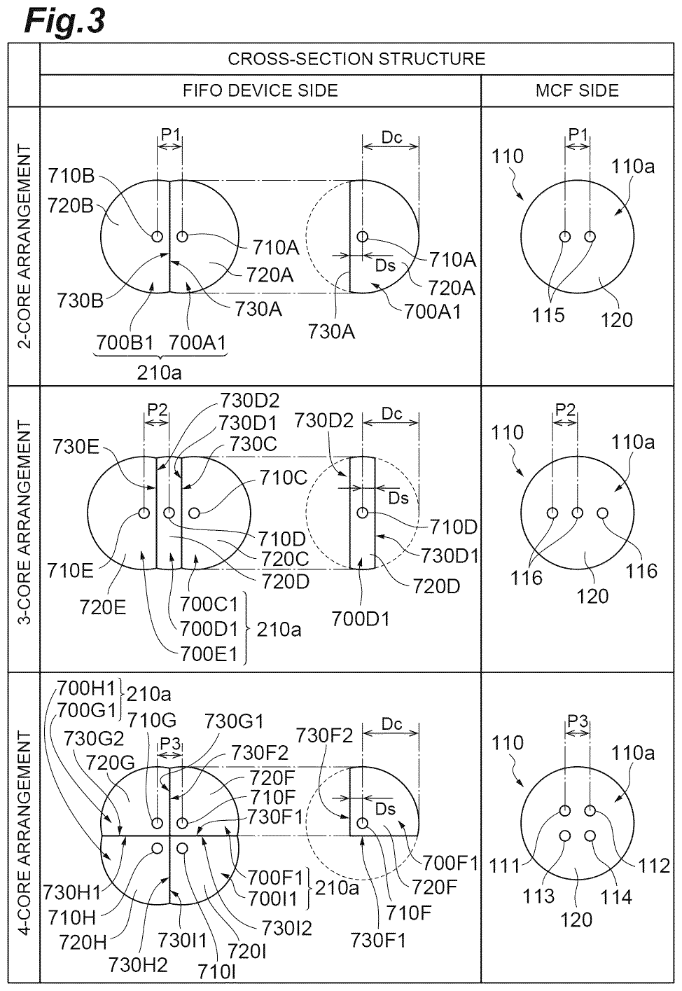

FIG. 2 is a diagram for explaining another example of the FIFO device applicable to the optical combiner of the present disclosure (in FIG. 2, referred to as “optical combiner 2”), and FIG. 3 is a diagram for explaining each end surface structure of the constituent parts of the optical combiner having a different number of cores as a modification of the optical combiner shown in FIG. 2 (in FIG. 3, referred to as “end surface structure”). It is noted that, in FIG. 3, as the end surface structure of the component, the end surface structure on the FIFO device side is shown on the left side (in FIG. 3, referred to as “FIFO device side”), and the end surface structure on the MCF side is shown on the right side (in FIG. 3, referred to as “MCF side”). The upper part of FIG. 2 (in FIG. 2, referred to as “manufacturing process”) shows a manufacturing process of an optical combiner incorporating another example of the FIFO device, and the lower part of FIG. 2 (in FIG. 2, referred to as “structure of SCF”) shows a structure of the SCF applied to another example of the FIFO device. Further, in the upper part of FIG. 3 (in FIG. 3, referred to as “2-core structure”), a FIFO device end surface structure and an MCF end surface structure composed of two SCFs are shown. The middle part of FIG. 3 (in FIG. 3, referred to as “3-core structure”) a FIFO device end surface structure composed of three SCFs and an end surface structure of an MCF are shown. In the lower part of FIG. 3 (in FIG. 3, referred to as “4-core structure”), a FIFO device end surface structure composed of four SCFs and an end surface structure of the MCF are shown.

As shown in the upper part of FIG. 2, when FIFO device 210 having two cores is constituted, first, two SCF components 700A and 700B are prepared as a plurality of single core optical fiber components (hereinafter, referred to as “SCF components”) which are optical waveguides. The total length of each of SCF components 700A and 700B is 2 n.

SCF component 700A includes a single core 710A, a cladding 720A surrounding single core 710A, a first fiber end surface 700A1 constituting a portion of first end surface 210a of FIFO device 210, and a second fiber end surface 700A2 constituting a portion of second end surface 210b of FIFO device 210. Further, a flat surface 730A having a length LL of about several cm along fiber axis AX is provided on the side surface of the tip portion of SCF component 700A including first fiber end surface 700A1.

On the other hand, SCF component 700B also includes a single core 710B, a cladding 720B surrounding single core 710B, a first fiber end surface 700B1 constituting a portion of first end surface 210a of FIFO device 210, and a second fiber end surface 700B2 constituting a portion of second end surface 210b of FIFO device 210. Further, a flat surface 730B having the length LL of about several cm along fiber axis AX is provided on the side surface of the tip portion of SCF component 700B including first fiber end surface 700B1.

For example, in SCF component 700A, flat surface 730A formed on the side surface is inclined with respect to fiber axis AX as shown in the lower part of FIG. 2. Thus, the area of first fiber end surface 700A1 provided with flat surface 730A is smaller than the area of second fiber end surface 700A2. SCF component 700B has the same structure as SCF component 700A.

Flat surfaces 730A and 730B of SCF components 700A and 700B having the above-described structure are bonded and fixed to each other in a state where the flat surfaces face each other. Thus, FIFO device 210 is obtained. First end surface 210a of FIFO device 210 is constituted by first fiber end surfaces 700A1 and 700B1 of SCF components 700A and 700B, which are fixed by adhesion. Further, second end surface 210b of FIFO device 210 is constituted by second fiber end surfaces 700A2 and 700B2 of SCF components 700A and 700B. It is noted that, second fiber end surfaces 700A2 and 700B2 of SCF components 700A and 700B are not fixed. First end surface 210a of FIFO device 210 constituted by two SCF components 700A and 700B is bonded and fixed to MCF 100. At this time, the core of MCF 100 is optically connected to the single core of the corresponding SCF among SCF components 700A and 700B.

Next, the end surface structures of both FIFO device 210 and MCF 100 optically connected to each other will be described using the example shown in FIG. 3. It is noted that, the FIFO device shown in the upper part of FIG. 3 is the example shown in FIG. 2, and is constituted of two SCF components 700A and 700B. The FIFO device shown in the middle part of FIG. 3 is constituted of three SCF components 700C, 700D, and 700E. The FIFO device shown in the lower part of FIG. 3 is constituted of four SCF components 700F, 700G, 700H, and 700I.

In each of SCF components 700A and 700B constituting the FIFO device shown in the upper part of FIG. 3, the cladding outer diameter is 125 μm and the core outer diameter is 30 μm. For example, SCF component 700A is provided with flat surface 730A on the side surface of the tip portion including first fiber end surface 700A1. On first fiber end surface 700A1, a straight line portion constituting the end surface contour corresponds to an edge of flat surface 730A, and a curved line portion of the end surface contour corresponds to an end surface edge of cladding 720A except for flat surface 730A. In detail, a shortest distance D_{S} from the center of single core 710A to the straight portion is 18.05 μm. The shortest distance D_{S} is shorter than the distance from the center of single core 710A to the curved portion, that is, a cladding radius Dc. SCF component 700B also has the same cross-section structure as SCF component 700A.

As described above, in first end surface 210a of FIFO device 210 constituted by first fiber end surface 700A1 of SCF component 700A and first fiber end surface 700B1 of SCF component 700B, the center-to-center distance between single core 710A and single core 710B is P1.

On the other hand, two cores 115 are arranged on MCF 100 optically connected to FIFO device 210, that is, substantially on first end surface 110a of glass optical fiber 110, and the center-to-center distance between two cores 115 is also set to P1. The cladding outer diameter of glass optical fiber 110 is 125 μm, the core diameter of each of cores 115 is 28 μm, and a center-to-center distance P1 of core 115 is 36.1 μm.

Each of SCF components 700C, 700D, and 700E prepared for constituting the FIFO device shown in the middle part of FIG. 3 has the same structure as SCF component 700A described above before the flat surface is formed. That is, SCF component 700C has a single core 710C and a cladding 720C, SCF component 700D has a single core 710D and a cladding 720D, and SCF component 700E has single core 710E and a cladding 720E. It is noted that, SCF components 700C and 700E arranged on the left and right sides are provided with one flat surfaces 730C and 730E, respectively, whereas SCF component 700D is provided with two flat surfaces 730D1 and 730D2. For example, in the case of SCF component 700C, a straight line portion constituting the end surface contour on a first fiber end surface 700C1 corresponds to the edge of flat surface 730C, and a curved line portion of the end surface contour corresponds to the end surface edge of cladding 720C excluding flat surface 730C. In the case of SCF component 700E, a straight line portion constituting the end surface contour on a first fiber end surface 700E1 corresponds to the edge of flat surface 730E, and a curved line portion of the end surface contour corresponds to the end surface edge of cladding 720E excluding flat surface 730E. Meanwhile, in the case of SCF component 700D provided with two flat surfaces 730D1 and 730D2, a straight line portion constituting the end surface contour on a first fiber end surface 700D1 corresponds to the edges of flat surfaces 730D1 and 730D2, and a curved line portion of the end surface contour corresponds to the end surface edge of cladding 720D excluding flat surfaces 730D1 and 730D2. In particular, referring to SCF component 700D, the shortest distance D_{S} from the center of single core 710D to the straight portion is shorter than the distance from the center of single core 710D to the curved portion, that is, the cladding radius Dc.

Flat surfaces 730C and 730E of SCF components 700C and 700E are bonded to two flat surfaces 730D1 and 730D2 of SCF component 700D having the end surface structure as described above, respectively, thereby obtaining FIFO device 210. At this time, first end surface 210a of FIFO device 210 is constituted by first fiber end surface 700C1 of SCF component 700C, first fiber end surface 700D1 of SCF component 700D, and first fiber end surface 700E1 of SCF component 700E. In first end surface 210a of FIFO device 210, the center-to-center distance between single core 710C and single core 710D and the center-to-center distance between single core 710D and single core 710E are each P2. On the other hand, three cores 116 are arranged on first end surface 110a of glass optical fiber 110 included in MCF 100 optically connected to FIFO device 210 having the end surface structure as described above, and the center-to-center distance between adjacent cores among three cores 116 is also set to P2.

Each of SCF components 700F, 700G, 700H, and 700I prepared for constituting the FIFO device shown in the lower part of FIG. 3 has the same structure as SCF component 700A described above before the flat surface is formed. That is, an SCF component 700F has a single core 710F and a cladding 720F, an SCF component 700G has a single core 710G and a cladding 720G, an SCF component 700H has a single core 710H and a cladding 720H, and an SCF component 700I has a single core 710I and a cladding 720I. It is noted that, two flat surfaces 730F1 and 730F2 are provided on the side surface of the tip portion including a first fiber end surface 700F1 of SCF component 700F, two flat surfaces 730G1 and 730G2 are provided on the side surface of the tip portion including a first fiber end surface 700G1 of SCF component 700G, two flat surfaces 730H1 and 730H2 are provided on the side surface of the tip portion including a first fiber end surface 700H1 of SCF component 700H, and two flat surfaces 730I1 and 730I2 are provided on the side surface of the tip portion including a first fiber end surface 700I1 of SCF component 700I.

For example, in the case of SCF component 700F, a straight line portion constituting an end surface contour on first fiber end surface 700F1 corresponds to edges of flat surfaces 730F1 and 730F2, and a curved line portion of the end surface contour corresponds to an end surface edge of cladding 720F excluding flat surfaces 730F1 and 730F2. In particular, referring to SCF component 700F, the shortest distance Dₛ from the center of single core 710F to the straight line portion is shorter than the distance from the center of single core 710F to the curved line portion, that is, the cladding radius Dc. Each of SCF components 700G, 700H, and 700I has an end surface structure similar to first fiber end surface 700F1 of SCF component 700F.

FIFO device 210 is obtained by SCF components 700F, 700G, 700H, and 700I having the end surface structure as described above.

Specifically, a flat surface 730F2 of SCF component 700F and a flat surface 730G1 of SCF component 700G are bonded and fixed, a flat surface 730G2 of SCF component 700G and a flat surface 730H1 of SCF component 700H are bonded and fixed, a flat surface 730H2 of SCF component 700H and a flat surface 730I1 of SCF component 700I are bonded and fixed, and a flat surface 730I2 of SCF component 700I and flat surface 730F1 of SCF component 700F are bonded and fixed.

At this time, first end surface 210a of FIFO device 210 is constituted by first fiber end surface 700F1 of SCF component 700F, first fiber end surface 700G1 of SCF component 700G, first fiber end surface 700H1 of SCF component 700H, and first fiber end surface 700I1 of SCF component 700I, and the center-to-center distances from single core 710F to single core 710G and single core 710I and the center-to-center distances from single core 710H to single core 710G and single core 710I are respectively P3. On the other hand, three cores 111 to 114 are arranged on first end surface 110a of glass optical fiber 110 included in MCF 100 optically connected to FIFO device 210 having the end surface structure as described above, and the center-to-center distance between adjacent cores among four cores 111 to 114 is also set to P3.

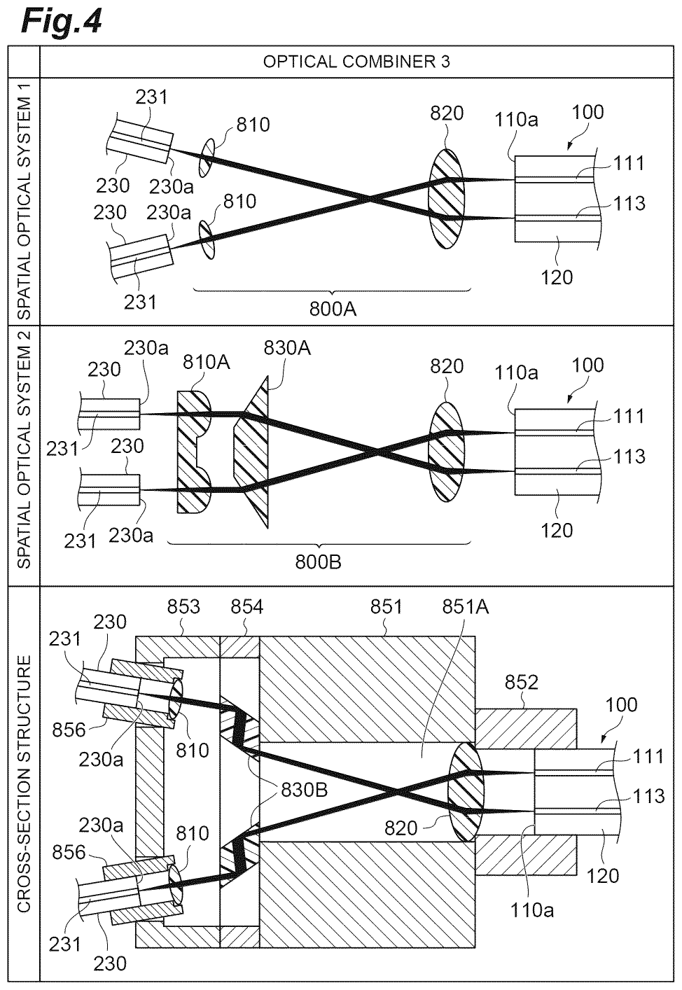

FIG. 4 is a diagram for explaining still another example of the FIFO device applicable to the optical combiner of the present disclosure (in FIG. 4, referred to as “optical combiner 3”). The upper part of FIG. 4 (in FIG. 4, referred to as “spatial optical system 1”) shows an example of a spatial optical system incorporated in the FIFO device. The middle part of FIG. 4 (in FIG. 4, referred to as “spatial optical system 2”) shows another example of the spatial optical system incorporated in the FIFO device. The lower part of FIG. 4 (in FIG. 4, referred to as “cross-section structure”) shows a cross-section structure of a FIFO device and its periphery applicable to the optical combiner of the present disclosure. It is noted that, the FIFO device shown in the lower part of FIG. 4 is an optical connection device having a function equivalent to that of FIFO device 210 which is an optical waveguide device shown in the lower part of FIG. 1 and the upper part of FIG. 2.

As disclosed in Non-patent literature 4, a spatial optical system 800A shown in the upper part of FIG. 4 is disposed between first end surface 110a of MCF 100, which is substantially the end surface of glass optical fiber 110, and an end surface 230a of the plurality of connection SCFs 230, and individually couples the plurality of cores 111 to 114 of MCF 100 and cores 231 of the plurality of connection SCFs 230 in a one-to-one manner. In spatial optical system 800A, a plurality of collimator lenses 810 corresponding to a plurality of connection SCFs 230 in a one-to-one manner is disposed on the side of connection SCFs 230, and GRIN lens 820 is disposed on the side of MCF 100. Each collimator lens 810 collects the input collimated light to core 231 of corresponding connection SCF 230. On the other hand, each collimator lens 810 collimates the light flux from corresponding core 231. GRIN lens 820 collimates the light flux from each of cores 111 to 114 of MCF 100 and outputs the collimated light to propagate through different optical paths. On the other hand, GRIN lens 820 collects collimated light input to different positions to any of cores 111 to 114 of corresponding MCF 100. Although the configuration example shown in the upper part of FIG. 4 is constituted only by a plurality of collimator lenses 810 and GRIN lens 820, a prism element for changing the optical path may be disposed between the plurality of collimator lenses 810 and GRIN lens 820.

A spatial optical system 800B shown in the middle of FIG. 4 is also disposed between first end surface 110a of MCF 100 and end surfaces 230a of the plurality of connection SCFs 230, and individually couples the plurality of cores 111 to 114 of MCF 100 and cores 231 of the plurality of connection SCFs 230 in a one-to-one manner. However, in spatial optical system 800B, as disclosed in Non-patent literature 5, collimator lens 810A having lens portions corresponding to a plurality of connections SCFs 230 in a one-to-one manner is disposed on the side of the plurality of connection SCF 230, and GRIN lens 820 is disposed on the side of MCF 100. Each lens portion of collimator lens 810A corresponding to the plurality of connection SCFs 230 in a one-to-one manner collects the input collimated light to core 231 of corresponding connection SCF 230. Meanwhile, each lens portion of collimator lens 810A collimates the light flux from corresponding core 231. GRIN lens 820 collimates the light flux from each of cores 111 to 114 of MCF 100 and outputs the collimated light to propagate through different optical paths. On the other hand, GRIN lens 820 collects collimated light input to different positions to any of cores 111 to 114 of corresponding MCF 100. Further, a prism 830A for collectively changing each of the optical paths from core 111 to core 114 of MCF 100 to core 231 of the plurality of connection SCFs 230 is arranged between collimator lens 810A and GRIN lens 820.

The FIFO device shown in the lower part of FIG. 4 is an optical connection device for optically connecting core 111 to core 114 of MCF 100 and core 231 of a plurality of connection SCFs 230 as disclosed in Non-patent literature 4, and has the same function as FIFO device 210 shown in the lower part of FIG. 1 and the upper part of FIG. 2. The FIFO device employs the above-described spatial optical system 800A including a prism 830B provided in a one-to-one correspondence with the plurality of connection SCFs 230. In detail, the FIFO device shown in the lower part of FIG. 4 includes a spatial optical system 800A including a prism 830B and a housing having a through hole 851A for accommodating spatial optical system 800A. The housing is constituted of a first end portion 852, a second end portion 853, a prism holder 854, and a body 851. First end portion 852 holds a tip portion including first end surface 110a of MCF 100. Second end portion 853 collectively holds tip portions including the end portions of the plurality of connection SCFs 230. Prism holder 854 holds prism 830B. GRIN lens 820 is disposed in the through hole opening of body 851. A plurality of collimator lenses 810 is fixed to an opening end of a lens holder 856 which functions as a connector attached to a tip portion of connection SCF 230.

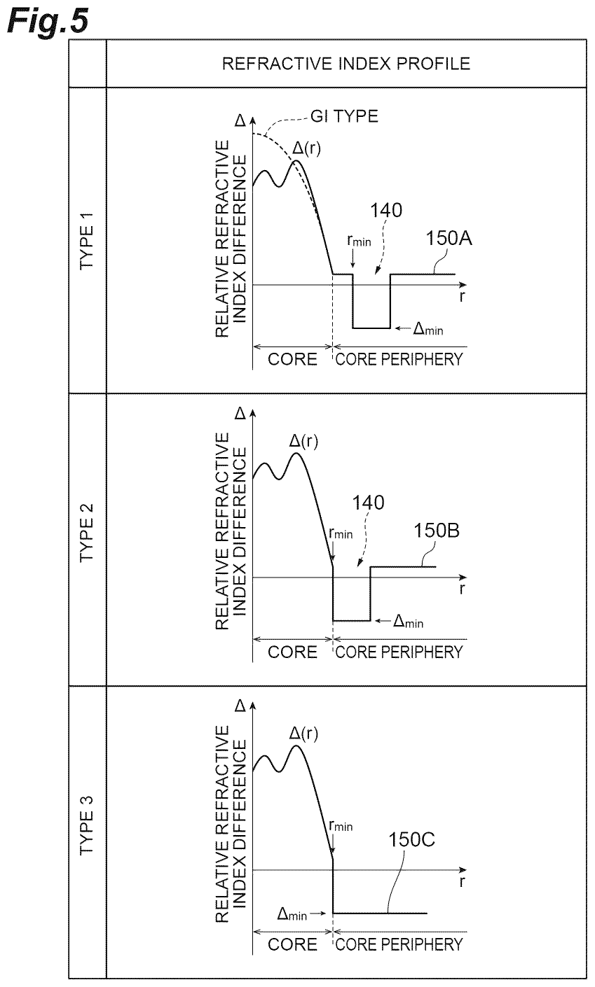

FIG. 5 is a diagram for explaining relative refractive index difference volume V (in FIG. 5, referred to as “refractive index profile”). In the upper part of FIG. 5 (in FIG. 5, referred to as “type 1”), an example of a refractive index profile 150A of the core and the core peripheral surface portion along the line L shown in the upper part of FIG. 1 is shown. The middle part of FIG. 5 (in FIG. 5, referred to as “type 2”) an example of a refractive index profile 150B of the core and the core peripheral surface portion along the line L shown in the upper part of FIG. 1 is shown. The lower part of FIG. 5 (in FIG. 5, referred to as “type 3”) a refractive index profile 150C of the core and the core peripheral surface portion along the line L shown in the upper part of FIG. 1 is shown.

Refractive index profile 150A of type 1 shown in the upper part of FIG. 5 is an example in which the plurality of trench portions 140 provided in one-to-one correspondence with cores 111 to 114 are provided. In refractive index profile 150A, each trench portion 140 constituting a portion of common cladding 120 is arranged at a position away from the corresponding core of cores 111 to 114. Further, each trench portion 140 becomes the lowest refractive index region included in common cladding 120. In the upper part of FIG. 5, an example of the GI-type refractive index profile of each core is shown by a dashed line.

Refractive index profile 150B of type 2 shown in the middle of FIG. 5 is also an example in which the plurality of trench portions 140 provided in one-to-one correspondence with cores 111 to 114 are provided.

In refractive index profile 150B, unlike refractive index profile 150A, each of trench portions 140 constituting the portions of common cladding 120 is in contact with a corresponding core of cores 111 to 114. Further, each trench portion 140 becomes the lowest refractive index region included in common cladding 120.

Refractive index profile 150C of type 3 shown in the lower part of FIG. 5 is an example in which the trench portion is not provided around each of cores 111 to 114. That is, in refractive index profile 150C, unlike refractive index profile 150A and refractive index profile 150B described above, common cladding 120 is in direct contact with each of cores 111 to 114. In refractive index profile 150C, the lowest refractive index region included in common cladding 120 is common cladding 120 itself.

The relative refractive index difference volume V of each core will be described using an example of three types of refractive index profiles from refractive index profile 150A of type 1 to refractive index profile 150C of type 3 as described above. In general, it is difficult to measure how many and what types of LP modes are guided in a multimode core. Thus, the relative refractive index difference volume V is used as an alternative index for measuring the number of guided LP modes. Refractive index profiles 150A to 150C shown in FIG. 5 are merely examples, and the relative refractive index difference volume V can be calculated even for refractive index profiles having different shapes.

By using the relative refractive index difference volume V, it is possible to roughly estimate how many types of LP mode is guided in the multimode core. The relative refractive index difference volume V is defined as rₘᵢₙ which is the distance from the core center to a point having the smallest relative refractive index difference in the periphery of the target core or a point closest to the core in the region having the smallest relative refractive index difference in the type 1 to type 3 shown in FIG. 5. When the relative refractive index difference with respect to the refractive index of pure silica at the point of the distance rₘᵢₙ is Δₘᵢₙ and the relative refractive index difference with respect to the refractive index of pure silica at the target core and the core periphery is Δ (r) as a function of the distance r from the core center, the relative refractive index difference volume V is calculated by the following (1):

$$[ Formula 1 ]$$

$$V = 2 π {\int }_{0}^{{r}_{min}} ( Δ ( r ) - {Δ}_{min} ) rdr \qquad ( 1 )$$

For a step-index type core in which the refractive index does not change in the core periphery, the relative refractive index difference of the core periphery to the refractive index of pure silica is Δₘᵢₙ, and the relative refractive index difference of the target core with respect to the refractive index of pure silica is Δ_{core}, a core radius is r, the relative refractive index difference volume V is expressed by the following formula (2):

$$[ Formula 2 ]$$

$$V = π ( {Δ}_{core} - {Δ}_{min} ) {r}^{2} \qquad ( 2 )$$

For a graded index core having no refractive index change in the core periphery, the relative refractive index difference of the core periphery to the refractive index of pure silica is Δₘᵢₙ, the largest relative refractive index difference of the target core with respect to the refractive index of pure silica is Δ_{core}, a core radius is r, the relative refractive index difference volume V is calculated by the following formula (3):

$$[ Formula 3 ]$$

$$V = π ( {Δ}_{core} - {Δ}_{min} ) {r}^{2} / 2 \qquad ( 3 )$$

The condition for guiding the ten types of LP mode (including the fundamental mode) in the wavelength 1260 nm in the multimode core is 2.2302≤V.

The condition for guiding the thirteen or more types of the LP mode in the wavelength 1260 nm in the multimode core is 2.9256≤V. Note that, by satisfying condition 2.2302≤V, the normalized frequency v_eff is 8.6 or more when the refractive index profile of the core is approximated to a step index type.
By satisfying condition 2.9256≤V, the normalized frequency v_eff is 9.85 or more when the refractive index profile of the core is approximated to a step index type.

MCF 100 of the present disclosure having the structure as described above can be applied to an optical waveguide for signal transmission, but can also be applied to other applications. As other application examples, various examples of the method of measuring a fiber characteristic of the present disclosure using MCF100 of the present disclosure will be described below. Specifically, measurement of the cutoff wavelength and measurement of the wavelength dependence of the transmission loss will be described for each core of the MCF to be measured, which is the measurement target.

### (Measurement of Cutoff Wavelength)

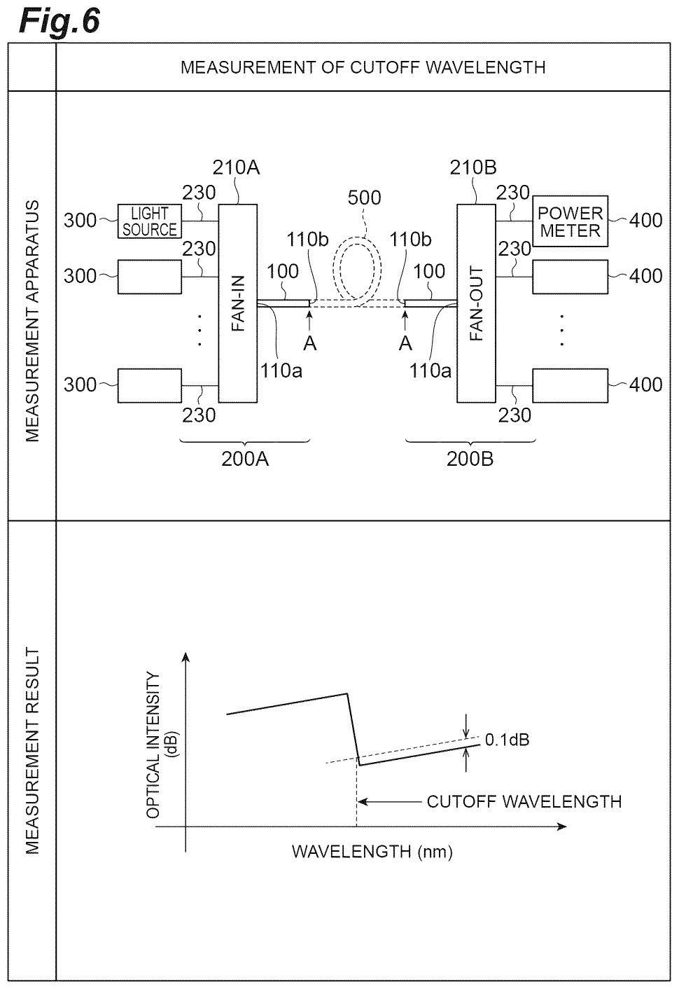

FIG. 6 is a diagram showing a measurement apparatus and a measurement result for measuring a cutoff wavelength as an example of a fiber characteristic of an MCF to be measured (in FIG. 6, referred to as “measurement of cutoff wavelength”). The upper part of FIG. 6 (in FIG. 6, referred to as “measurement apparatus”) shows an example of the configuration of a measurement apparatus for measuring the cutoff wavelength of the measurement target. The lower part of FIG. 6 (in FIG. 6, referred to as “measurement result”) shows an example of the measurement result by the measurement apparatus shown in the upper part of FIG. 6.

The measurement apparatus shown in the upper part of FIG. 6 includes a plurality of light sources 300 each outputting measurement light, a plurality of power meters 400, and optical combiner 200A and optical combiner 200B arranged on both the input side and the output side of a measurement target 500. Optical combiner 200A and optical combiner 200B each have the structure shown in the lower part of FIG. 1, the upper part of FIG. 2, or the lower part of FIG. 4. Measurement target 500 is an MCF to be measured, and optical combiner 200A and optical combiner 200B are both optical combiners of the present disclosure.

Optical combiner 200A includes MCF 100 of the present disclosure having multimode cores 111 to 114, FAN-IN device 210A, and the plurality of connection SCFs 230 each having a multimode core. Second end surface 110b of MCF 100 is connected to the input-side end surface of measurement target 500 in a state where each of cores 111 to 114 is optically connected to the cores of measurement target 500 in a one-to-one manner at a fusion point A. First end surface 110a of MCF 100 is connected to FAN-IN device 210A in a state where each of cores 111 to 114 is optically connected to the multimode core of FAN-IN device 210A in a one-to-one manner.

The plurality of light sources 300 are arranged so as to correspond to the cores of measurement target 500 in a one-to-one manner, and the plurality of connection SCFs 230 are arranged so as to optically connect the plurality of light sources 300 and the corresponding cores of FAN-IN device 210A.

On the other hand, optical combiner 200B includes MCF 100 of the present disclosure having multimode cores 111 to 114, FAN-OUT device 210B, and the plurality of connection SCFs 230 each having a multimode core. Second end surface 110b of MCF 100 is connected to the output-side end surface of measurement target 500 in a state in which each of cores 111 to 114 is optically connected to the cores of measurement target 500 in a one-to-one manner at other fusion point A. First end surface 110a of MCF 100 is connected to FAN-OUT device 210B in a state where each of cores 111 to 114 is optically connected to the multimode core of FAN-OUT device 210B in a one-to-one manner. The plurality of power meters 400 are arranged so as to correspond to the cores of measurement target 500 in a one-to-one manner, and the plurality of connection SCFs 230 are arranged so as to optically connect the plurality of power meters 400 and the corresponding cores of FAN-OUT device 210B.

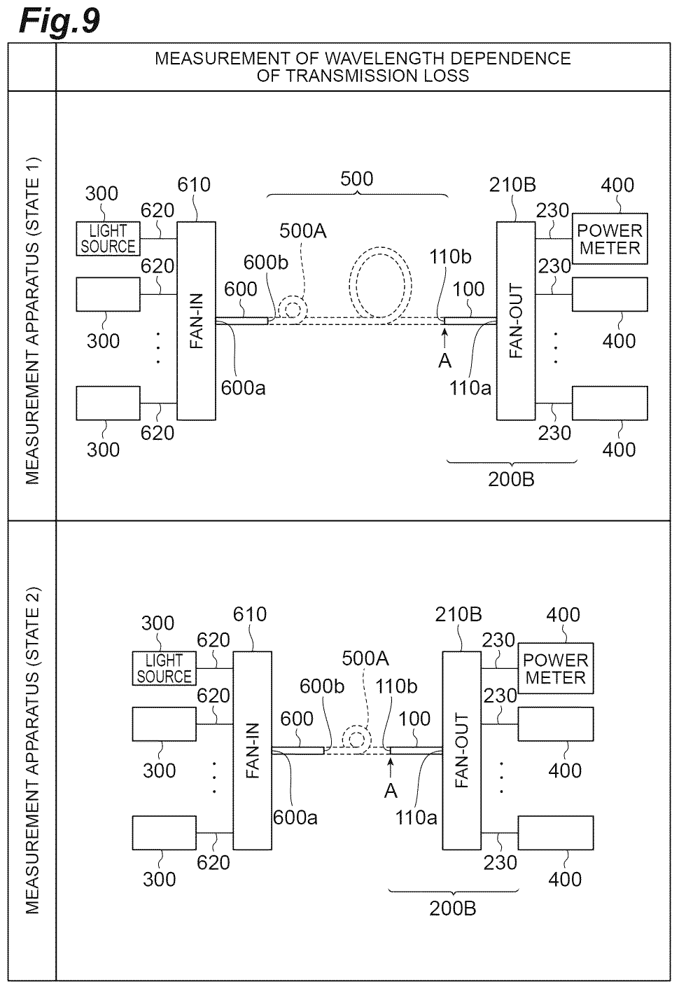

At least one of optical combiner 200A and optical combiner 200B may be replaced with a combination of a general optical combiner (standard optical combiner) shown in the upper part of FIG. 9 and the lower part of FIG. 9 and MCF 100 of the present disclosure. Such a standard optical combiner has a structure similar to optical combiner 200 shown in the lower part of FIG. 1, the upper part of FIG. 2, or the lower part of FIG. 4, and includes an FIFO device 610, an MCF 600 for connection, and a plurality of connection SCFs 620 for connection. However, each core of FIFO device 610, each core of MCF 600, and each core of the plurality of connection SCFs 620 are all single-mode cores.

In the measurement apparatus having the structure as described above, for each core (target core) of measurement target 500, the intensity of the measurement light input from light source 300, which is a tunable light source corresponding to the target core, to optical combiner 200A and then output from second optical combiner 200B via the target core is measured while changing the wavelength of the measurement light. After this measurement step is performed for all the cores of measurement target 500, the cutoff wavelengths of all of the plurality of cores of measurement target 500 are determined as the fiber characteristic based on the measurement result of measurement target 500. In the lower part of FIG. 6, the wavelength dependence of the optical intensity is shown as the measurement result for one core that has become the target core.

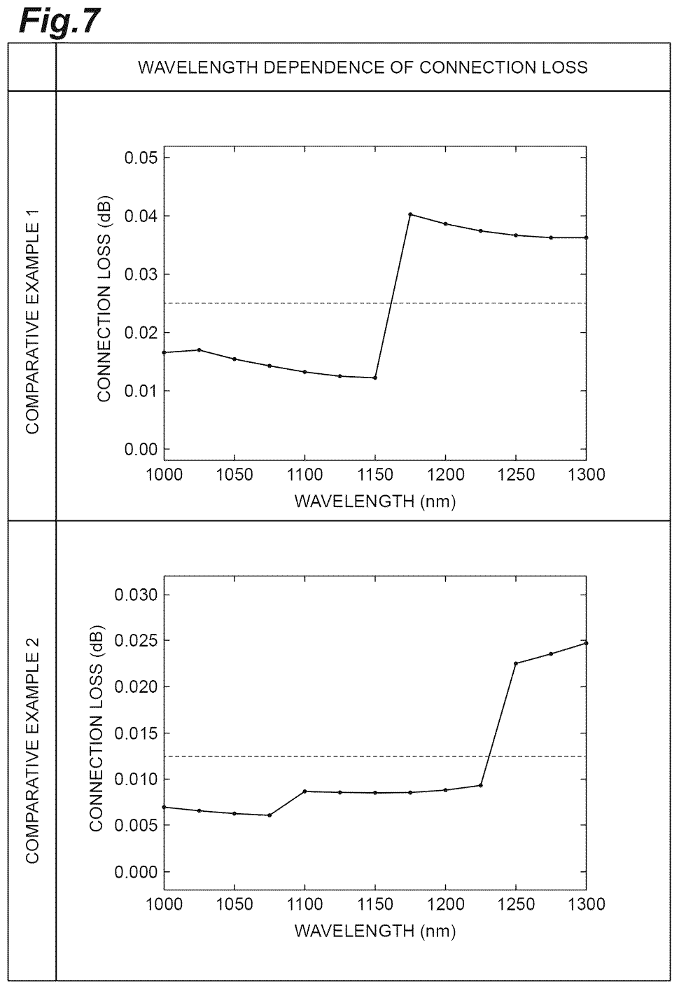

FIG. 7 is a graph showing the wavelength dependence of connection loss for various samples that do not satisfy the connection condition required for the MCF of the present disclosure in the measurement of cutoff wavelength (in FIG. 7, referred to as “wavelength dependence of connection loss”). The upper part of FIG. 7 (in FIG. 7, referred to as “comparative example 1”) shows the wavelength dependence of the connection loss in the case where the MCF is such that the tenth LP mode from the fundamental mode is cut off in the range from wavelength 1150 nm to wavelength 1175 nm, only the nine types of LP mode is guided in the wavelength range equal to or longer than wavelength 1175 nm, and there is an axial misalignment of 3 μm. The lower part of FIG. 7 (in FIG. 7, referred to as “comparative example 2”) shows the wavelength dependence of the connection loss in the case of an MCF in which the thirteenth LP mode from the fundamental mode is cut off in the range from wavelength 1225 nm to wavelength 1250 nm and only the twelve types of LP modes are guided in the wavelength range equal to or greater than wavelength 1250 nm, and in which there is an axial misalignment of 3 μm.

When the cutoff wavelength of each core is determined, as disclosed in Non-patent literature 2, as shown in the graph of the lower part of FIG. 6, the intersection of a correction line obtained by raising a line obtained by linearly approximating the long wavelength side by 0.1 dB and the measurement datum is determined as the cutoff wavelength. The correction line is a dashed line shown in the lower part of FIG. 6. Thus, the connection loss when the measurement light is input to and output from the MCF to be measured, which is measurement target 500, needs to be at least 0.05 dB or less in total. That is, the connection loss at fusion point A between the MCF to be measured and MCF 100 of the present disclosure needs to be 0.025 dB or less as the first connection condition required for MCF 100 of the present disclosure.

In the graph of comparative example 1 shown in the upper part of FIG. 7, the connection loss greatly increases in the long wavelength side section in which nine or less types of LP mode is guided, compared to the short wavelength side section in which ten or more types of LP mode of including the fundamental mode is guided, and the connection loss at the time of input and output of the measurement light exceeds 0.025 dB. Thus, the condition that ten or more types of LP modes are guided can be the first connection condition required for MCF 100 of the present disclosure. Since the cutoff wavelength is generally defined as 1260 nm or less in the ITU-T G652 standard, an MCF in which ten or more types of LP modes are guided in the wavelength 1260 nm is one of the specifications required for the MCF of the present disclosure.

Furthermore, in order to reduce measurement errors caused by connection loss, the connection loss at the time of input and output of measurement light to and from the measurement target may be 0.025 dB or less in total. That is, the connection loss at fusion point A between the MCF to be measured, which is measurement target 500, and MCF 100 of the present disclosure may be 0.0125 dB or less as the second connection condition required for MCF 100 of the present disclosure.

In the graph of comparative example 2 shown in the lower part of FIG. 7, the connection loss increases in the long wavelength side section in which twelve types or less of LP mode of is guided, compared to the short wavelength side section in which the LP mode of thirteen or more types including the fundamental mode is guided, and the connection loss at the time of input and output of the measurement light exceeds 0.0125 dB. Thus, the condition that the LP mode of thirteen or more types are guided in the wavelength 1260 nm can be the second connection condition required for MCF 100 of the present disclosure.

Here, in the present specification, the state in which “the LP mode is guided” means a state in which the transmission loss of the LP mode after the LP mode to be a target propagates through each core in the MCF100 of the present disclosure in 1 m propagation in the core to be guided is 3.01 dB or less. As can be seen from FIG. 6 and FIG. 7, the effect of reducing the connection loss in the MCF to be measured when the ten types of LP mode or the thirteen types of LP mode is guided can be sufficiently achieved even when the powers of the tenth LP mode to the thirteenth LP mode counted from the fundamental mode are assumed to be half. The lengths of MCF 100 of the present disclosure may be practically equal to or longer than 1 m. Thus, the condition for MCF 100 of the present disclosure to obtain a desired technical effect, that is, the waveguide condition required for MCF 100 of the present disclosure, can be that the power attenuation when a plurality of LP modes propagates in 1 m is 50% or less, that is, the transmission loss is 3.01 dB or less.

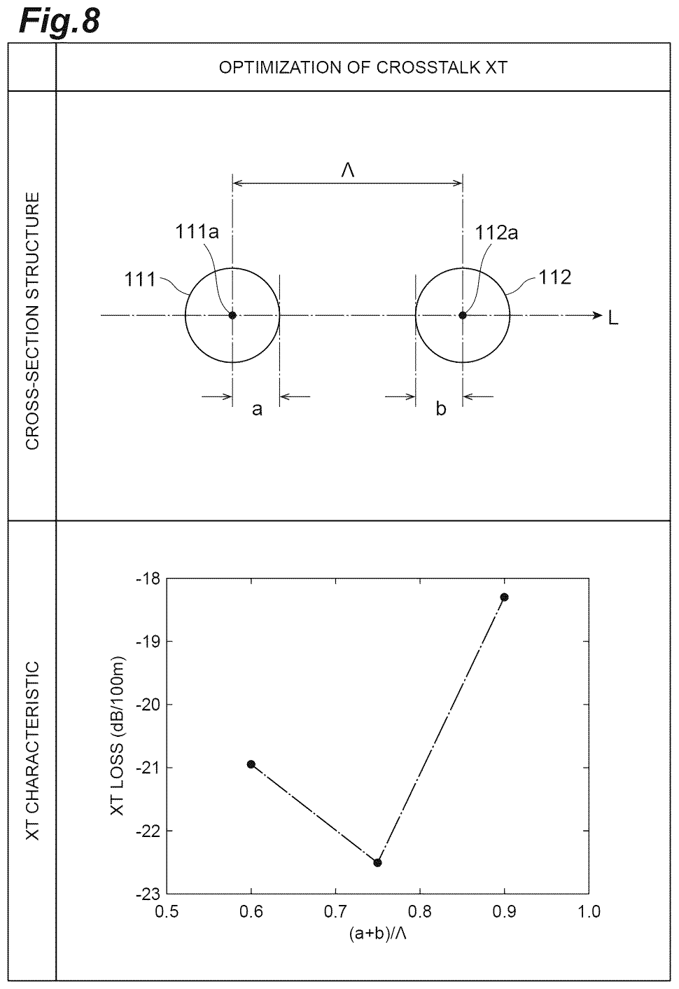

FIG. 8 is a diagram for explaining the XT condition applied to the MCF of the present disclosure (in FIG. 8, referred to as “optimization of crosstalk XT”). In the upper part of FIG. 8 (in FIG. 8, referred to as “cross-section structure”), a portion of a cross-section orthogonal to fiber axis AX of MCF 100 of the present disclosure is shown. The lower part of FIG. 8 (“XT characteristic” in FIG. 8) shows the (a+b)/Λ dependence of the XT loss at the wavelength 1300 nm.

In a general multi-mode MCF, when ten or more types of LP modes including a specified mode are guided through each core, the core diameter needs to be increased, which results in an increase in XT. Since this XT causes measurement noise, a mechanism for reducing XT is required when ten or more types of LP modes are guided through each core of the multimode MCF. In a general MCF, the center-to-center distance Λ of the cores in the adjacent relationship is 34 μm to 46 μm, and therefore, at least the core diameter needs to be suppressed to 46 μm or less. In this specification, for the cores in MCF having an adjacent relationship, a relationship between two cores having the shortest center-to-center distance among the plurality of the cores in the MCF is defined as an adjacent relationship. Thus, each core of the multimode MCF for reducing connection loss described in Patent literature 3 has a core diameter of 50 μm, and therefore, the multimode MCF cannot be applied to the MCF of the present disclosure as it is.

In order to solve the above-described problem, the center-to-center distance Λ between cores in an adjacent relationship is 34 μm to 46 μm, and the core arrangement condition (a+b)/Λ satisfies the following condition may be satisfied.

$$0.675 < ( a + b ) / Λ < 0.825 .$$

The parameters of the core arrangement condition (a+b)/Λ are defined as shown in the upper part of FIG. 8.
That is, a is the radius of core 111, and b is the radius of a core 112 in the adjacent relationship with core 111. A is the distance of the line segment connecting a center 111a of core 111 and a center 112a of core 112, that is, the center-to-center distance between core 111 and core 112.

When the core arrangement condition (a+b)/Λ is small, the core diameter is small, and thus, even when the amount of axial misalignment is the same, the power coupling of the core propagation mode to the mode in which the electric field distribution spreads to the outside of the core is facilitated in the MCF having a small core diameter, compared to the case where the core diameter is large.

Thus, XT is likely to occur in the MCF having a small core diameter. On the other hand, when the core arrangement condition (a+b)/Λ is large, the distance between the cores is narrowed, and thus XT is likely to occur also in this case. The above-mentioned conditions are intermediate between these two contradictory actions and are optimal for reducing XT. As shown in the lower part of FIG. 8, XT becomes minimum in the vicinity of (a+b)/Λ=0.75.
Further, when (a+b)/Λ is in the range of 0.60 to 0.90, XT increases. Thus, (a+b)/Λ may be in a range of 0.6375 to 0.8625, or may be in a range of 0.675 to 0.825. The range of 0.60 to 0.90 is a range of −0.15 to +0.15 with reference to 0.75. The range of 0.6375 to 0.8625 is a range of −0.15×3/4 to +0.15×3/4 with reference to 0.75. The range of 0.675 to 0.825 is a range of −0.15/2 to +0.15/2 with reference to 0.75.

In general, when a high-order LP mode is guided in the core, attenuation is larger than that of a low-order LP mode when the high-order LP mode is guided in the same distance. Thus, when the cutoff wavelength is measured using an optical fiber in which the relative refractive index difference volume V is increased and more LP modes can be guided in the core, for example, in MCF 100 of a first optical combiner 200A shown in the upper part of FIG. 6, all the LP modes are substantially uniformly excited, and therefore the measurement light from light source 300 is more greatly attenuated. Since the intensity of light source 300 used for measuring the cutoff wavelength is small in many cases, it is preferable that the attenuation of the light intensity is not too large. In order to satisfy such a condition, the relative refractive index difference volume V (μm²) may be 15 or less, or may be 11 or less.

### (Measurement of Wavelength Dependence of Transmission Loss)

FIG. 9 is a diagram showing a measurement apparatus for measuring the wavelength dependence of transmission loss as an example of the fiber characteristic of the measurement target (in FIG. 9, referred to as “measurement of wavelength dependence of transmission loss”). The upper part of FIG. 9 (in FIG. 9, referred to as “measurement apparatus (state 1)”) shows an apparatus configuration for performing measurement on the entire measurement target (first measurement target) as the first measurement step. The lower part of FIG. 9 (in FIG. 9, referred to as “measurement apparatus (state 2)”) shows an apparatus configuration for performing measurement with a portion of the predetermined cutback length (cutback portion) separated from the first measurement target as a second measurement target, as a second measurement step. Note that the state 1 shown in the upper part of FIG. 9 and the state 2 shown in the lower part of FIG. 9 have the same apparatus configuration except for the measurement target.

The measurement apparatus shown in the upper part of FIG. 9 and the lower part of FIG. 9 includes a plurality of light sources 300 each outputting measurement light as a tunable light source, a plurality of power meters 400, a first optical combiner disposed on measurement target 500 or the input side of a cutback portion 500A, and a second optical combiner 200B including MCF 100 of the present disclosure disposed on measurement target 500 or the output-side of cutback portion 500A. It is noted that, measurement target 500 is the MCF to be measured which is the first measurement target, and cutback portion 500A is the portion of the MCF to be measured which is the second measurement target. The first optical combiner is a standard optical combiner, and second optical combiner 200B is an optical combiner of the present disclosure.

The first optical combiner has a structure similar to optical combiner 200 shown in the lower part of FIG. 1, the upper part of FIG. 2, or the lower part of FIG. 4, and includes FIFO device 610 functioning as a FAN-IN device, MCF 600 for connection, and a plurality of connection SCFs 620 for connection, and each core of FIFO device 610, each core of MCF 600, and each core of the plurality of connection SCFs 620 are all single-mode cores. A second end surface 600b of MCF 600 is connected to the input-side end surface of measurement target 500 in a state in which the cores of MCF 600 are optically connected to the cores of measurement target 500 in a one-to-one manner. A first end surface 600a of MCF 600 is connected to FIFO device 610 in a state where each core of MCF 600 is optically connected to the single-mode core of FIFO device 610 in a one-to-one manner. A plurality of light sources 300 are arranged so as to correspond to the cores of measurement target 500 in a one-to-one manner, and the plurality of connection SCFs 620 are arranged so as to optically connect the plurality of light sources 300 and the corresponding cores of FIFO device 610.

On the other hand, second optical combiner 200B includes MCF 100 of the present disclosure having cores 111 to 114 of the multi-mode, FAN-OUT device 210B, and the plurality of connection SCFs 230 each having the core of the multi-mode. Second end surface 110b of MCF 100 is connected to the output-side end surface of measurement target 500 in a state in which cores 111 to 114 are optically connected to the cores of measurement target 500 in a one-to-one manner at fusion point A. First end surface 110a of MCF 100 is connected to FAN-OUT device 210B in a state where each of cores 111 to 114 is optically connected to the multimode core of FAN-OUT device 210B in a one-to-one manner.

The plurality of power meters 400 are arranged so as to correspond to the cores of measurement target 500 in a one-to-one manner, and the plurality of connection SCFs 230 are arranged so as to optically connect the plurality of power meters 400 and the corresponding cores of FAN-OUT device 210B.

In the apparatus shown in the upper part of FIG. 9, the first measurement step is performed with measurement target 500 as the first measurement target. On the other hand, in the apparatus configuration shown in the lower part of FIG. 9, the second measurement step is performed with cutback portion 500A of the predetermined cutback length, which is a portion of measurement target 500 and is separated from measurement target 500, as the second measurement target. In this device configuration, the end surface on the incident side of cutback portion 500A is in a state of being connected to the first optical combiner, and the end surface on the exit side of cutback portion 500A is connected to second end surface 110b of MCF 100 of the present disclosure at fusion point A. It is noted that, in the first measurement step, the intensity of the measurement light that is input to the first optical combiner and then output from second optical combiner 200B via measurement target 500 is measured. In the second measurement step, in a state in which only cutback portion 500A separated from measurement target 500 is left, the intensity of the measurement light output from second optical combiner 200B through cutback portion 500A after being input to the first optical combiner is measured. After the first measurement step and the second measurement step, the wavelength dependence of the transmission loss of all the cores of the remaining portion of measurement target 500 after cutback portion 500A is separated is determined as the fiber characteristic based on the measurement results of the first measurement step and the second measurement step. Specifically, the measurement result of the first measurement step is intensity data of the measurement light output from each core of measurement target 500. The measurement result of the second measurement step is the intensity of the measurement light output from each core of cutback portion 500A. By subtracting the measurement result of the second measurement step from the measurement result of the first measurement step, the wavelength dependence of the transmission loss of each of all the cores in the remaining portion excluding cutback portion 500A in measurement target 500 after the cutback is determined.

It is noted that, second optical combiner 200B of the measurement apparatus shown in the upper part of FIG. 9 and the lower part of FIG. 9 can be replaced with a general optical combiner which is a standard optical combiner having a structure identical to optical combiner including MCF 600 for connection, FIFO device 610, and the plurality of connection SCFs 620. In this case, MCF 100 of the present disclosure is disposed between the output-side end surface of measurement target 500 or cutback portion 500A and second end surface 600b of MCF 600 of the replaced standard optical combiner.

Although the LP mode is described above, a mode group including the LP mode may be used. That is, the mode group may include a mode other than the LP mode.

### REFERENCE SIGNS LIST

100 . . . MCF
110 . . . glass optical fiber
110a, 210a . . . first end surface
110b, 210b . . . second end surface
111 to 116, 220 . . . core
111a, 112a . . . center
120 . . . common cladding
130 . . . resin covering
140 . . . trench portion
150A to 150C . . . refractive index profile
200, 200A, 200B . . . optical combiner
210 . . . FIFO device
210A . . . FAN-IN DEVICE
210B . . . FAN-OUT DEVICE
230 . . . connection SCF
230a . . . end surface
231 . . . core
300 . . . light source
400 . . . power meter
500 . . . measurement target
500A . . . cutback portion
600 . . . MCF
610 . . . FIFO device
620 . . . connection SCF
700A to 700I . . . SCF component
700A1 to 700I1 . . . first fiber end surface
700A2, 700B2 . . . second fiber end surface
710A to 710I . . . core
720A to 720I . . . cladding
730A, 730B, 730C, 730D1, 730D2, 730E, 730F1, 730F2, 730G1, 730G2,
730H1, 730H2, 730I1, 730I2 . . . flat surface
800A, 800B . . . spatial optical system
810, 810A . . . collimator lens
820 . . . GRIN lens
830A, 830B . . . prism
851 . . . body
852 . . . first end portion
853 . . . second end portion
854 . . . prism holder
856 . . . lens holder
A . . . fusion point
AX . . . fiber axis

What is claimed is:

1. A multicore optical fiber comprising:
a plurality of cores extending along a center axis; and
a common cladding surrounding each of the plurality of cores,
wherein, at a wavelength of 1260 nm, ten or more types of LP modes including a fundamental mode are guided in each of the plurality of cores by 1 m or more.

2. The multicore optical fiber according to claim 1,
wherein a relative refractive index difference volume V (μm²) of each of the plurality of cores defined on a cross-section of the multicore optical fiber orthogonal to the center axis, the relative refractive index difference volume V (μm²) being obtained by integration of a relative refractive index difference of a target core with respect to a lowest refractive index region included in the common cladding in the cross-section from a center of the target core to the lowest refractive index region, satisfies a relationship below.
2.2302≤V

3. The multicore optical fiber according to claim 1,
wherein the LP modes are thirteen or more types of LP modes.

4. The multicore optical fiber according to claim 3,
wherein a relative refractive index difference volume V (μm²) of each of the plurality of cores defined on a cross-section of the multicore optical fiber orthogonal to the center axis, the relative refractive index difference volume V (μm²) being obtained by integration of a relative refractive index difference of a target core with respect to a lowest refractive index region included in the common cladding in the cross-section from a center of the target core to the lowest refractive index region, satisfies a relationship below.
2.9256≤V

5. A multicore optical fiber comprising:
a plurality of cores extending along a center axis; and
a common cladding surrounding each of the plurality of cores,
wherein a relative refractive index difference volume V (μm²) of each of the plurality of cores defined on a cross-section of the multicore optical fiber orthogonal to the center axis, the relative refractive index difference volume V (μm²) being obtained by integration of a relative refractive index difference of a target core with respect to a lowest refractive index region included in the common cladding in the cross-section from a center of the target core to the lowest refractive index region, satisfies a relationship below.
2.2302≤V

6. The multicore optical fiber according to claim 5,
wherein the relative refractive index difference volume V (μm²) satisfies a relationship below.
2.9256≤V

7. The multicore optical fiber according to claim 2,
wherein the relative refractive index difference volume V (μm²) is 15 or less.

8. The multicore optical fiber according to claim 7,
wherein the relative refractive index difference volume V (μm²) is 11 or less.

9. The multicore optical fiber according to claim 1,
wherein a first core having a radius a (μm) and a second core having a radius b (μm) satisfy an adjacent relationship in which a center-to-center distance Λ (μm) is shortest among the plurality of cores, and the first core and the second core satisfy a relationship below.
$$34 \leq Λ \leq 46 \\ 0.6375 < ( a + b ) / Λ < 0.8625$$

10. The multicore optical fiber according to claim 9,
wherein a first core having a radius a (μm) and a second core having a radius b (μm) satisfy an adjacent relationship in which a center-to-center distance Λ (μm) is shortest among the plurality of cores, and the first core and the second core satisfy a relationship below.
$$34 \leq Λ \leq 46 \\ 0.675 < ( a + b ) / Λ < 0.825$$

11. The multicore optical fiber according to claim 1,
wherein each of the plurality of cores has a GI-type refractive index profile.

12. The multicore optical fiber according to claim 1, further comprising:
a plurality of trench portions corresponding one-to-one to the plurality of cores and each disposed to surround an outer circumference of a corresponding one of the plurality of cores, the plurality of trench portions each having a refractive index lower than a refractive index of the common cladding.

13. An optical combiner comprising:
the multicore optical fiber according to claim 1; and
an optical waveguide device having a first end surface having a predetermined first core arrangement, a second end surface having a second core arrangement differing from the first core arrangement, and a plurality of cores provided between the first end surface and the second end surface, the plurality of cores between the first end surface and the second end surface being optically connected one-to-one, at the first end surface, to the plurality of cores of the multicore optical fiber.

14. The optical combiner according to claim 13,
wherein the optical waveguide device includes, as the plurality of cores, a plurality of single core optical fiber components each having a first fiber end surface constituting a portion of the first end surface, a second fiber end surface constituting a portion of the second end surface, and a single core extending from the first fiber end surface to the second fiber end surface,
wherein each of the plurality of single core optical fiber components has, at a side surface of a tip portion including the first fiber end surface, one or more flat surfaces, and
wherein, with the respective flat surfaces being fixed to each other in a state of facing each other, the first fiber end surfaces of the plurality of single core optical fiber components constitute the first end surface of the optical waveguide device.

15. The optical combiner according to claim 14,
wherein the plurality of single core optical fiber components are two single core optical fiber components.

16. An optical combiner comprising:
the multicore optical fiber according to claim 1; and
an optical connection device configured to function as an optical waveguide device,
wherein the optical connection device has
a first end portion configured to hold a tip portion including an end surface of the multicore optical fiber,
a second end portion configured to hold a tip portion of each of a plurality of single core optical fibers each having a core corresponding one-to-one to one of the plurality of cores of the multicore optical fiber,
a through hole extending from the first end portion to the second end portion and configured to cause a plurality of light fluxes to propagate, between the multicore optical fiber and the plurality of single core optical fibers, along different optical paths, and
a spatial optical system configured to optically couple each of the plurality of cores of the multicore optical fiber to a corresponding one of the cores of the plurality of single core optical fibers.

17. The optical combiner according to claim 16,
wherein the spatial optical system includes a GRIN lens.

18. A method of measuring a fiber characteristic, the method comprising:
preparing, as a measurement target, a measurement-target multicore optical fiber having a first end surface and a second end surface and having a plurality of cores each extending from the first end surface toward the second end surface;
preparing a first optical transmission path disposed on a side of the first end surface or the second end surface of the measurement target and configured to function as an input-side optical transmission path or an output-side optical transmission path, the first optical transmission path including a first multicore optical fiber having a structure identical to a structure of the multicore optical fiber according to claim 1;
optically connecting the plurality of cores of the first multicore optical fiber one-to-one to the plurality of cores of the measurement target and thereby constituting a fiber line including the measurement target;
measuring, for each of a plurality of cores of the fiber line, intensity of measurement light while changing a wavelength of the measurement light, the measurement light being output from an output-side end surface of the fiber line after being input to an input-side end surface of the fiber line; and
determining, as a fiber characteristic, a cutoff wavelength of each of the plurality of cores of the measurement target based on a measurement result relating to the measurement target.

19. The method of measuring a fiber characteristic according to claim 18,
wherein the first optical transmission path is an optical combiner including the first multicore optical fiber and a first optical waveguide device, and
wherein the first optical waveguide device has a first end surface having a predetermined first core arrangement, a second end surface having a second core arrangement differing from the first core arrangement, and a plurality of cores provided between the first end surface and the second end surface, the plurality of cores between the first end surface and the second end surface being optically connected one-to-one, at the first end surface, to the plurality of cores of the first multicore optical fiber.

20. The method of measuring a fiber characteristic according to claim 18, the method comprising:
further preparing a second optical transmission path positioned on a side opposite to the first optical transmission path with respect to the measurement target and configured to function as the input-side optical transmission path or the output-side optical transmission path, the second optical transmission path including a second multicore optical fiber having a structure identical to the structure of the first multicore optical fiber; and
optically connecting the plurality of cores of the second multicore optical fiber one-to-one to the plurality of cores of the measurement target such that the measurement target is placed between the first multicore optical fiber and the second multicore optical fiber to thereby constitute the fiber line.

21. The method of measuring a fiber characteristic according to claim 20,
wherein the second optical transmission path is an optical combiner including the second multicore optical fiber and a second optical waveguide device, and
wherein the second optical waveguide device has a first end surface having a predetermined first core arrangement, a second end surface having a second core arrangement differing from the first core arrangement, and a plurality of cores provided between the first end surface and the second end surface, the plurality of cores between the first end surface and the second end surface being optically connected one-to-one, at the first end surface, to the plurality of cores of the second multicore optical fiber.

22. A method of measuring a fiber characteristic, the method comprising:
preparing, as a first measurement target, a measurement-target multicore optical fiber having a first end surface and a second end surface and having a plurality of cores each extending from the first end surface toward the second end surface;
preparing an output-side optical transmission path disposed on a side of the second end surface of the first measurement target, the output-side optical transmission path including the multicore optical fiber according to claim 1;
optically connecting the plurality of cores of the multicore optical fiber one-to-one to the plurality of cores of the first measurement target and thereby constituting a first fiber line including an entirety of the first measurement target;
performing a first measurement step by measuring, for each of a plurality of cores of the first fiber line, intensity of measurement light, the measurement light being output from an output-side end surface of the first fiber line after being input to an input-side end surface of the first fiber line;
performing a second measurement step by optically connecting a plurality of cores of a second measurement target one-to-one to the plurality of cores of the multicore optical fiber to thereby constitute a second fiber line from which the first measurement target excluding the second measurement target is removed, the second measurement target being a portion of the first measurement target and being a portion separated from the first measurement target and having a predetermined cutback length, and then measuring, for each of a plurality of cores of the second fiber line, intensity of measurement light, the measurement light being output from an output-side end surface of the second fiber line after being input to an input-side end surface of the second fiber line; and
determining, as a fiber characteristic, wavelength dependence of a transmission loss of each of the plurality of cores of the first measurement target from which the second measurement target has been separated, based on a measurement result of the first measurement step and a measurement result of the second measurement step.

23. The method of measuring a fiber characteristic according to claim 22,
wherein the output-side optical transmission path is an optical combiner including the multicore optical fiber and an optical waveguide device, and
wherein the optical waveguide device has a first end surface having a predetermined first core arrangement, a second end surface having a second core arrangement differing from the first core arrangement, and a plurality of cores provided between the first end surface and the second end surface, the plurality of cores between the first end surface and the second end surface being optically connected one-to-one, at the first end surface, to the plurality of cores of the multicore optical fiber.
